(19) United States
(12) Patent Application Publication
(10) Pub. No.: US 2003/0079221 A1
(43) Pub. Date: Apr. 24, 2003

(54) Secure method for providing negotiable discount coupons to consumers using a distributed processing network

(76) Inventor: David Wayne Bruner, Provo, UT (US)

Correspondence Address: Angus C. Fox, III, 4093 N. Imperial Way, Provo, UT, 84604-5386, US

(21) Appl. No.: 10/171,505

(22) Filed: Jun. 12, 2002

Related U.S. Application Data
(63) Continuation-in-part of application No. 09/982,632, filed on Oct. 18, 2001.

(51) Int. Cl. G06F 17/60; H04N 7/16; G06F 3/00; H04N 5/445; G06F 13/00

(52) U.S. Cl. 725/23; 725/61; 705/14

(57) ABSTRACT

A convenient and secure method is provided via a distributed processing network, such as the Internet, for allowing registered consumers to personally print on security paper available only from the provider of the on-line printing service, selected discount coupons, which have been preauthorized by a provider of goods or services, on a restricted basis, and in a manner which makes counterfeiting of such coupons extremely difficult. The invention also provides a method for tracking the use of the coupons with an on-line accessible and updatable database, so that their authenticity may be verified and the buying habits of the consumers may be ascertained. The providers of the goods and services are allowed access to the database and are able to enter data related to the use of tendered coupons and view accumulated data and statistical analyses of that data.

This is a continuation-in-part of application Ser. No. 09/982,632, which was filed on Oct. 17, 2001, and is titled “METHOD FOR ALLOCATING NEGOTIABLE DISCOUNT COUPONS TO CONSUMERS USING A DISTRIBUTED PROCESSING NETWORK.”

### BACKGROUND OF THE INVENTION

1. Field of the Invention

The present invention relates to methods for printing discount offers and related data on a consumer-controlled printer utilizing pre-formatted secure paper to create negotiable discount coupons and, more particularly, to a method for ensuring that the individually completed coupons are limited in number and not easily counterfeitable.

2. Description of the Prior Art

In the highly commercialized and competitive U.S. economy, businesses view negotiable discount coupons as a primary means of introducing new products and services to consumers, as well as a means for rekindling relationships between businesses and consumers. As a general rule, the more saturated an industry is from a economic supply perspective, the greater the proliferation of discount coupons. Typically, coupons for substantial discounts are offered for goods and services for which frequent repeat purchases are common. The highly-competitive service industries generate large quantities of discount coupons, as do manufacturers and retailers of myriad consumer goods and food products. The primary goal of a discount coupon campaign is to introduce consumers, who are unfamiliar with, or not regularly using, an offered product or service, a low-risk opportunity to purchase the product or service. In other words, providers of products or services are willing to provide substantial discounts to consumers, often at close to cost, with the hope of enticing those consumers to try their product or service at a price which consumers find difficult to resist. The hope, of course, is that the consumer will be sufficiently impressed with the quality and value of the product or service so as to become a frequent repeat customer. At least for the restaurant industry and other similarly situated businesses, a secondary goal is that of generating sufficiently large walk-in clientele so that the business has the appearance of success. In order to accomplish these goals, merchants will often offer limited-use deep discount coupons to consumers. One major problem with discount coupon campaigns is that they tend to create a large pool of repeat customers who repeatedly take advantage of periodically-available coupons featuring deep discounts, which makes catering to that pool a losing, break-even or, at best, a low-margin proposition. Another major problem is counterfeiting of discount coupons, which can result in a much larger number of discounts given than were authorized.

For these reasons, fine restaurants with high overhead costs have historically been reluctant to engage in the distribution of discount coupons. A two-for-the-price-of-one coupon at a high-end restaurant can—depending on the restaurant's location in the country—easily represent a discount of ten to one hundred dollars. Thus, such businesses would distribute deep-discount coupons only if the distribution of the coupons and the number issued could be tightly controlled. Given the tremendous advances in copying, digital scanning, and digital manipulation technology over the past decade, the counterfeiting of deep-discount coupons is more than a theoretical problem. Manufacturers, retailers and other service providers who desire to distribute discount coupons to consumers face similar security and profitability issues.

The favored methods of distributing product and service discount coupons have long been via mail and via newspaper delivery. However, within the last decade, distribution of coupons over the Internet has become commonplace. A number of individuals have filed patents covering various aspects of electronic distribution of coupons. For example, U.S. Pat. No. 4,674,041, titled METHOD AND APPARATUS FOR CONTROLLING THE DISTRIBUTION OF COUPONS, which issued to Chester L. Lemon and Bill Al Kelly on Jun. 16, 1987, discloses a system for monitoring and controlling the distribution of product coupons from a plurality of remote terminals located at the point of sale. The system includes video display terminals for displaying a collection of coupons available for selection, as sell as a method for monitoring and controlling the number of coupons distributed. Some six years later, on Sep. 28, 1993, U.S. Pat. No. 5,249,044, titled PRODUCT INFORMATION STORAGE, DISPLAY, AND COUPON DISPENSING SYSTEM, issued to Henry Von Kohorn. This later patent discloses a system for generating product coupons at remote locations. The system includes a coupon generating unit connected to a television, or other receiver of information signals broadcast from a central location. Product coupons, which have selectively entered product information thereon, can be printed by the coupon generating unit. On Jun. 2, 1998, U.S. Pat. No. 5,761,648, titled INTERACTIVE MARKETING NETWORK AND PROCESS USING ELECTRONIC CERTIFICATES, issued to Steven M. Golden and five other inventors. This patent discloses a data processing system for issuing electronic certificates through online networks of personal computers, televisions, or other devices with video monitors or telephones. Each certificate includes transaction and identification data, and can be printed on a printer connected to a personal computer. Consumers can access the data processing system online, review available offers, and print those in which they have interest. Certificate issuers may also access the data processing system online, and can create offers having limitations on use, and revise existing offers. Limitations may include the total number of certificates to be issued and the number which may be issued to a single consumer. On Mar. 16, 1999, U.S. Pat. No. 5,884,277, titled PROCESS FOR ISSUING COUPONS FOR GOODS OR SERVICES TO PURCHASERS AT NON-SECURE TERMINALS, issued to Vinod Khosla. This patent discloses a method for the automated issuance of a coupon containing both clear text transcripts and encrypted transcripts which identify both a purchaser and goods or services purchased on-line at a non-secure terminal over a public network. The coupon is redeemable for the goods or services so purchased. Shortly thereafter, on May 25, 1999, U.S. Pat. No. 5,907,830, titled ELECTRONIC COUPON DISTRIBUTION, issued to Peter and Andrew Engel. The Engels disclose an electronic coupon distribution system providing on-line coupon information for a potential consumer using a personal computer connected to a host computer. The consumer may specify product preferences or search and view coupons of interest. The consumer may then download from the host computer coupons that may be printed on a printer connected to the potential consumer's personal computer. It appears that Engels contribution to the already crowded field of coupon downloading may be limited to printing certain indicia on the downloaded coupons, which identified the address of the client computer. Finally, on Nov. 20, 2001, U.S. Pat. No. 6,321,208, titled METHOD AND SYSTEM FOR ELECTRONIC DISTRIBUTION OF PRODUCT REDEMPTION COUPONS, issued to Craig W. Barnett, et al. On Jan. 1, 2002, U.S. Pat. No. 6,336,099 to the same inventors, added some additional claims via a continued prosecution application. These two patents disclose a method and system for the electronic distribution of product redemption coupons to remote personal computers located at users' homes. A centrally located repository, such as an online service provider or web site on the Internet, stores packages of coupon data for downloading on demand to the user's computer. The user may view, select, sort and print desired coupons from the downloaded package. The user's demographic as well as coupon selection data is provided back to the online service and coupon distributor and issuers for subsequent marketing analysis. The online service can perform subsequent coupon processing on previously downloaded coupon packages such as variation of discount amounts. In addition, the online service provider can also determine how many times a particular coupon was viewed. Upon redemption by the store via a coupon redeeming center, transaction data is also supplied to the coupon issuers and distributor for integration into marketing analysis. The electronic coupon system is said to be secure due to the inclusion of user-specific identification indicia printed thereon.

On Mar. 8, 2001, the Emerging Technologies Subcommittee of the Coupon Information Corporation, which is located at 115-D South St. Asaph Street, Alexandria, Va. 22314, published a sixteen-page report titled The Security Risks of Internet Print-at-Home Coupons. At the time of publication, members of the Coupon Information Corporation included twenty-six of the major U.S. consumer product manufacturers that issue discount coupons. The authors of the report identified counterfeiting as a major concern, and demonstrated that print-at-home coupons were vulnerable to reproduction, as well as alterations to increase in values, decrease purchase requirements, eliminate or defeat security codes, smudge bar codes, eliminate or extend expiration dates, modify disclaimers, and/or modify terms and conditions of use. In addition, the mere existence of print-at-home programs encouraged the creation of completely bogus coupons. The report also noted that membership to coupon printing sites on the Internet could often be established using a bogus name, address and phone number, as well as incorrect gender and age, and an E-mail address active for only a single day. The authors further observed that only a general lack of acceptance of print-at-home coupons by major consumer product manufacturers may have prevented the development of significant organized criminal activity in that area. The print-at-home coupon vendors that do currently operate have focused their security safeguards on consumer fraud. Such safeguards are generally effective against only amateur thieves. The authors concluded that print-at-home coupon programs are inherently vulnerable to fraud, and that manufacturers who utilize such programs do so at their own peril and that of the industry.

Planet U, Inc., a provider of grocery store discount coupons through the mail, in connection with its upons.com Internet website, has also concluded that print-at-home coupons expose the manufacturers to fraud and potentially large financial liabilities.

Given the manifold potential security problems with current print-at-home coupon programs, a convenient system for providing print-at-home negotiable discount coupons to consumers on a secure and restricted basis is urgently needed, if manufacturers and retailers are to utilize the full marketing potential of distributed processing networks, such as the Internet.

### SUMMARY OF THE INVENTION

A method is provided for restricting the distribution of negotiable discount coupons to individual consumers, using pre-formatted secure paper, via a distributed processing network. The method is implemented by providing a server computer system accessible via the network. The server system is provided with a searchable consumer database containing discount offers, authorized by participating merchants, retailers, and/or manufacturers, which may be applied to the purchase of specific goods and/or services. The offers are generally subject to restrictions imposed by the authorizing merchant, retailer or manufacturer with regard to the number of times a single consumer may take advantage of a particular discount offer. As a rule, most, if not all of the offers are subject to restrictions imposed by the authorizing entity.

The method also requires the establishment of a pool of registered subscribing member consumers, each of whom may access the server via the network, using a client computer system. Each of the available offers may be graphically displayed on the consumer's client system. The client computer system may be a personal computer or Internet appliance. The client computer system must be connected to a printer accessible to the consumer.

One or more sheets of security paper, having coupon shells pre-printed thereon, are delivered to each of the subscribing consumers by a program manager, so that discount offer data may be printed thereon by the consumer, thereby creating negotiable discount coupons. The security paper, itself, may incorporate water marks, colored fibers, a polymer security thread, pre-printed coupon formatting (also referred to as coupon shells), which may be printed with concentric fine lines, microprinting, color-shifting ink, and/or other identifiable, but not easily duplicatable features. Each of the heretofore identified security features is found on currency now being printed by the U.S. government. In addition to the features inherent in the security paper, each coupon shell may include other identifying features, such as bar codes, holographic stamps similar to those placed on boxes of distributed software, two dimensional codes, a membership identification number and/or serial numbers. Each of the sheets is, preferably, perforated in order to facilitate singulation of multiple coupons contained on a single sheet. Laser-cut perforations, using a special pattern, may be employed as a security feature.

In order to accurately position the printing of discount offer data on the provided security paper, the subscribing consumer is asked to calibrate his printer. Calibration is accomplished by having the consumer print a test pattern on a calibration sheet provided by the program manager. The test pattern consists of two pairs of intersecting lines, which represent the opposite corner locations of a rectangular, default-positioned-and-sized coupon printing field. The calibration sheet has a preprinted x-y grid, each axis of which includes a sequential scale of alphanumeric characters. With the test pattern printed and superimposed on the preprinted grid, the consumer is asked to identify the two corners in terms of the alphanumeric x-y coordinates. This calibration information can be provided to the server, or alternatively, to a plug-in module on the local client system. Using this information, printing of coupon data on the blank coupon shells can be adjusted to correspond to the position and size of printable fields on the coupon shell.

For a presently preferred embodiment of the invention, a plug-in module provided by the program manager and downloadable from the server system, is loaded on the client system. The plug-in module controls printing of coupon information in coupon shells, in response to data received by the plug-in module from the server system. The data from the server system, which may include text data, graphics data and calibration data, is sent to an Internet browser program running on the client system. The browser detects the incoming data from the server and sends it to the plug-in module. The plug-in module parses the data and uses available calibration data—whether resident from the client system or received from the server system—to format the data for the local printer. The plug-in module then sends the prepared information to the printer, where it may be printed within the blank coupon shells preprinted on a sheet of security paper. For a preferred embodiment of the invention, the calibration information is stored on the client system to avoid the necessity of repeatedly downloading information which remains constant for a particular printer.

For an alternative embodiment of the invention, printing is controlled by a print utility running on the server. Calibration information is uploaded to the server from the client system when each print operation is prepared.

A registered consumer may print the data, and thereby complete a negotiable coupon, for any discount offer which is authorized for his use. However, the number of coupons which may be completed by a single consumer for each authorized discount may be limited in accordance with the restrictions imposed by the merchant, retailer, or manufacturer.

Each coupon is preferably printed with both the name of the registered consumer and a unique identification number so that it may be individually tracked by the database. If the privacy of the consumers is of concern, the name may be eliminated from the coupon. In addition, a serial number identifying the consumer is pre-printed within each coupon shell on the security paper. Such a system provides two levels of coupon tracking: the serial number is identified with each shipment of security paper to a registered consumer, while a coupon identification number is associated with the printing of a single coupon by a registered consumer. To complicate the task of forging serial numbers or coupon identification numbers printed on coupons, either one or both numbers may be printed as both a base-10 number and as a corresponding number in a base other than 10, or as a Roman numeral. As base-2 (binary) numbers and base-16 (hexadecimal) numbers are easily identifiable and translatable, a number in a base other than 2 or 16 is considered preferable.

As an additional level of security, rules for negotiability of the coupon may be printed thereon, and preferably on the reverse side. For example, one of the rules should certainly be that coupons with noticeable alternations will not be honored. Another may identify the features of the security paper and state that if the coupon does not have all of those features, it should not be honored. The coupon may also refer the merchant to a secure online database for further validation of the coupon. Certain characteristics of the coupon should be kept confidential to make counterfeiting by the public more difficult. In addition, it is desirable that the name of the on-line company providing the coupons be pre-printed on the security paper within each of the coupon shells. It may also state that the pre-printed number on the coupon will correlate or correspond to the number on the consumer's discount club membership, which is provided by the on-line company.

The invention also provides a method for tracking the use of the coupons with an on-line seller database, accessible and updatable by the merchants, retailers and manufacturers, so that the validity of coupons may be verified and the buying habits of the consumer members may be ascertained. Both the serial numbers and the identification number may be entered in the on-line seller database. By accessing the seller database, the serial number will allow the provider of goods or services to verify that the registered consumer, whose name is printed on the coupon, has used the security paper with the pre-printed coupon shells that was assigned to him, and, by accessing the coupon identification number, that the coupon's use is authorized under the terms of its discount program. By using these means, merchants, retailers and manufacturers will be able to monitor the security of the system as it relates to their particular discount offerings. The providers of the goods and services are also allowed access to the database for the entering of data related to the use of tendered coupons, and view accumulated data and statistical analyses of that data. The statistical analyses afford the merchant, retailer, or manufacturer an opportunity to better tailor its products and advertising to customer behavior. A database tailored for use by restaurants, for example, may identify each consumer member by zip code and sign-up date. Additionally, the database may keep track of information, such as member visit frequency, total ticket value after discount, as well as the discount type and amount, so that restaurant management can gauge the effectiveness of the discount program.

### BRIEF DESCRIPTION OF THE DRAWINGS

FIG. 1 is a block diagram of a distributed processing network in which four client systems are configured to implement the present invention;

FIG. 2 is a sample of a sheet of security paper having four, contiguous, preprinted, blank discount coupons, each of which includes tear perforations at the outer perimeter thereof;

FIG. 3 is a sample printing of a test pattern on a preprinted calibration sheet;

FIG. 4 is a sample of a trial printout of four contiguous discount coupons, each of which has been made nonnegotiable by printing the word VOID thereon;

FIG. 5 is a sample of a final printout of four contiguous discount coupons;

FIG. 6 is a simplified block diagram of the discount program server, including programs and databases resident thereon; and

FIG. 7 shows several sample of laser perforation patterns, which can be used to singulate multiple coupon shells printed on a single sheet of security paper.

### PREFERRED EMBODIMENT OF THE INVENTION

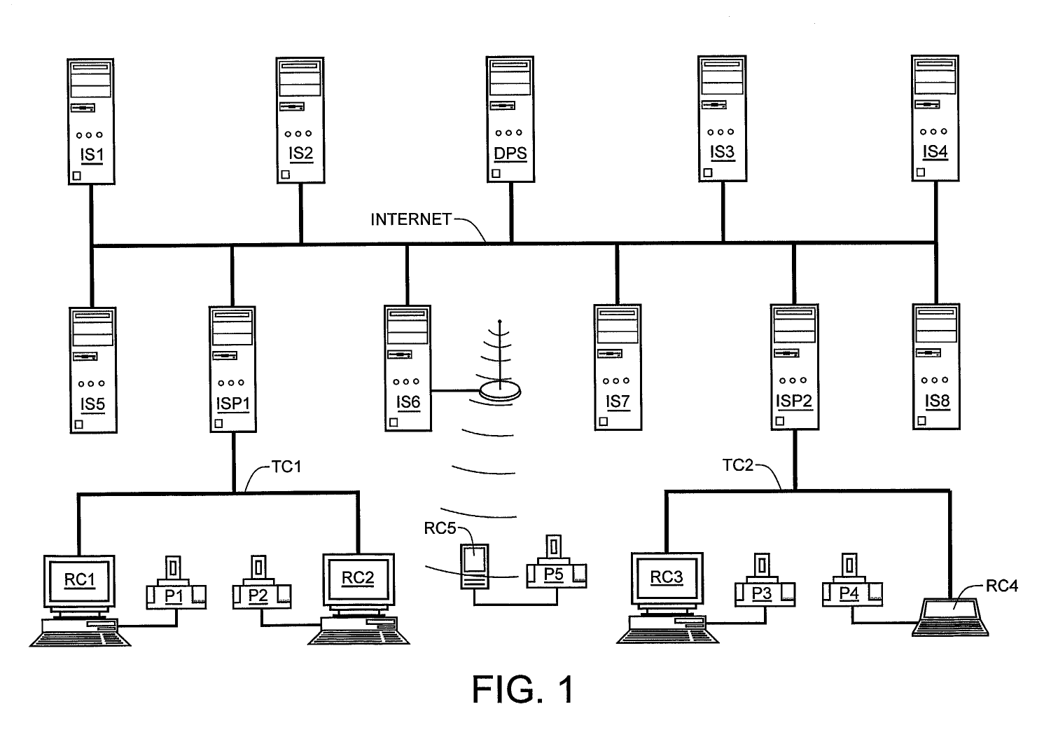

A method is provided for restricting the distribution of negotiable discount coupons to individual consumers utilizing security paper having coupon shells preprinted thereon, and a distributed processing network. The method requires a program manager, a group of individually identifiable consumers who desire to acquire negotiable discount coupons, and merchants, retailers and/or manufacturers who are willing to provide negotiable discount coupons, at least some of which are made available on a limited or restricted basis. The method will now be described with reference to the attached drawing FIGS. 1 through 5.

Referring now to FIG. 1, the method is implemented by providing a discount program server computer system DPS accessible via a distributed processing network 101, such as the Internet. The program server system DPS is provided with a searchable database (not shown in this drawing figure) of discount offers, authorized by participating merchants, retailers and/or manufacturers, which may be applied to the purchase of specific goods and/or services. The offers are generally subject to restrictions imposed by the authorizing merchant, retailer or manufacturer with regard to the number of times a single consumer may take advantage of a particular discount offer. As a rule, most of the offers are subject to restrictions imposed by the authorizing entity.

Still referring to FIG. 1, the method requires the establishment of a pool of registered subscribing consumers, each of whom may access the server via a network 101, using respective client computer systems RC1, RC2, RC3, RC4, or RC5 and obtain information related to available discount offers. Each of the available offers may be graphically displayed on the consumer's client system. The client computer system may be a personal computer or an internet appliance. Internet appliances are typically small, inexpensive, lightweight, instant-on devices that connect to the Internet. They may have simplified, single-use operating systems and limited mass storage capacity. Current incarnations include television set-top boxes, consoles, terminals, smart phones and handhelds. Each client computer system RC1, RC2, RC3, RC4 and RC5 may be coupled to the network 101 in a variety of different ways. For the sake of example, RC1, RC2 and RC3 are personal computers; RC4 is a terminal; and RC5 is a handheld device. RC1 is coupled to a first internet service provider ISP1 via a dial-up telephone connection DTC; client system RC2 is coupled to a second internet service provider ISP2 via a DSL connection DSL; client systems RC3 and RC4 are coupled to a third internet service provider ISP3 via the same cable network connection CNC; and client system RC5 is coupled to a fourth internet service provider ISP4 via a wireless network which employs a transmit/receive antenna TMA. Each client computer system RC1, RC2, RC3, RC4 and RC5 has associated therewith a printer P1, P2, P3, P4 and RC1, RC2, RC3, RC4 and RC5 has associated therewith a printer P1, P2, P3, P4 and P5, respectively. Also coupled to a typical distributed processing network 101, such as the internet, are multiple internet servers IS1, IS2, IS3, IS4 and IS5.

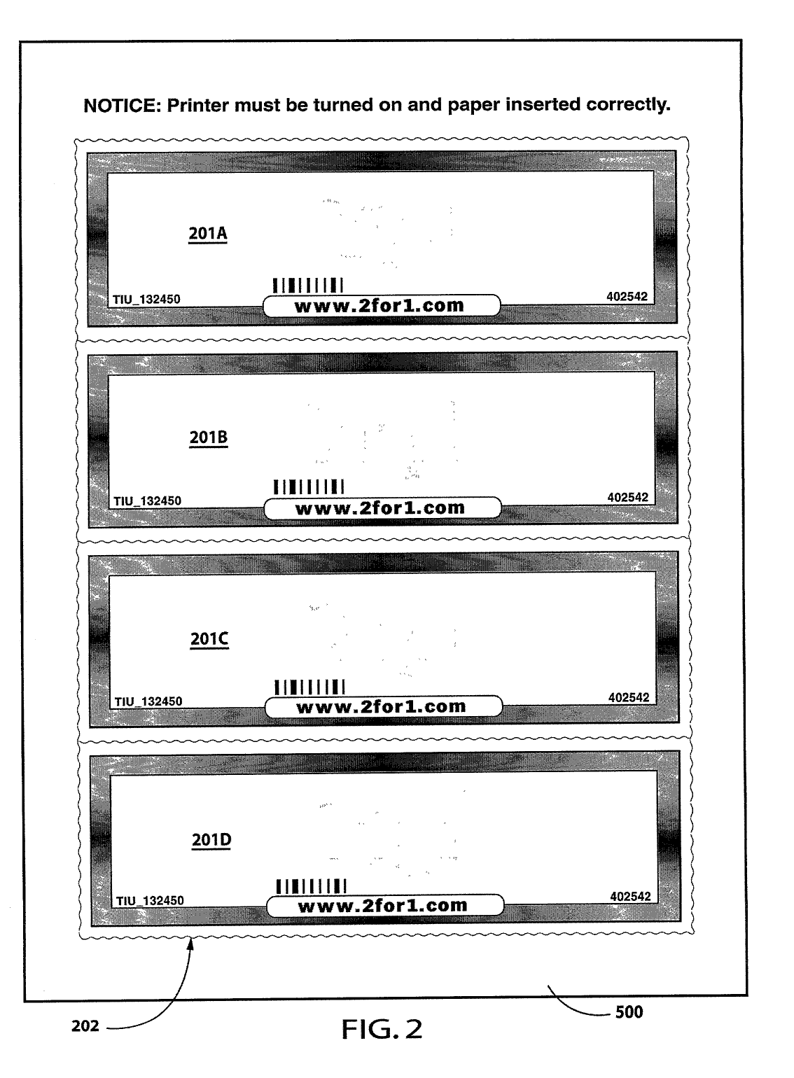

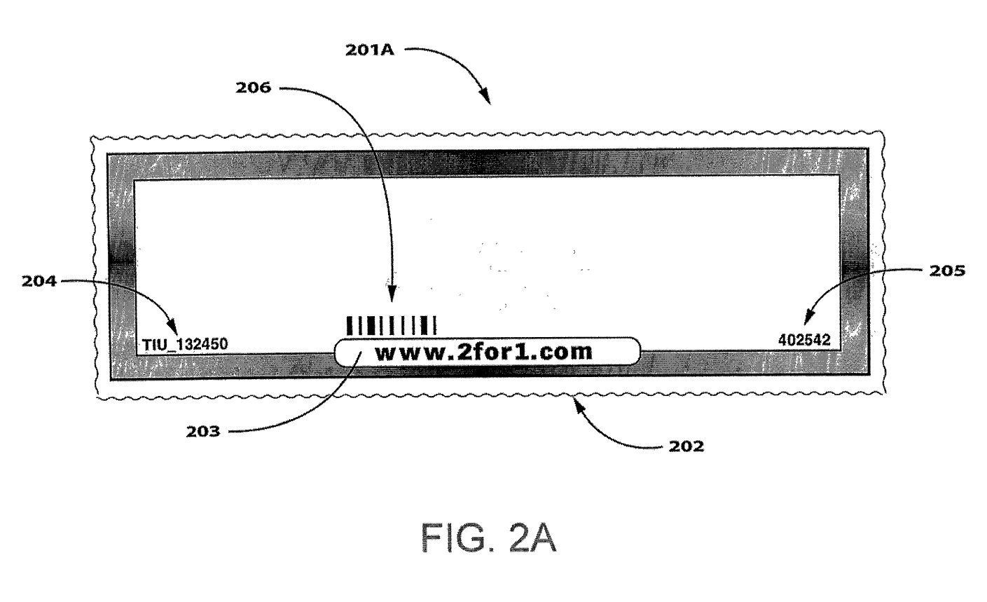

Referring now to FIG. 2, multiple sheets of security paper (an example of which is the sample 200) are delivered to each of the subscribing consumers by the program manager (in this particular case, www.2for1.com, inc.). Each sheet of security paper 200 includes multiple, preprinted coupon shells (201A, 201B, 201C, and 201D). The security paper, itself, may incorporate water marks, colored fibers, a polymer security thread, coupon formatting (also referred to as coupon shells), which may be printed, at least in part, with color-shifting ink, and which may incorporate concentric fine lines, microprinting, and/or other identifiable, but not easily duplicatable features. Each of the heretofore identified security features is found on currency now being printed by the U.S. government. Each of these features is discussed in a pamphlet titled New Designs for Your Money, published by the Office of the Treasurer of the United States. This pamphlet, which accompanies this application, is incorporated in the application, by reference, in its entirety. The security paper may also include other identifying features, such as bar codes, holographic stamps such as those placed on boxes of distributed software, two-dimensional codes, and/or serial numbers.

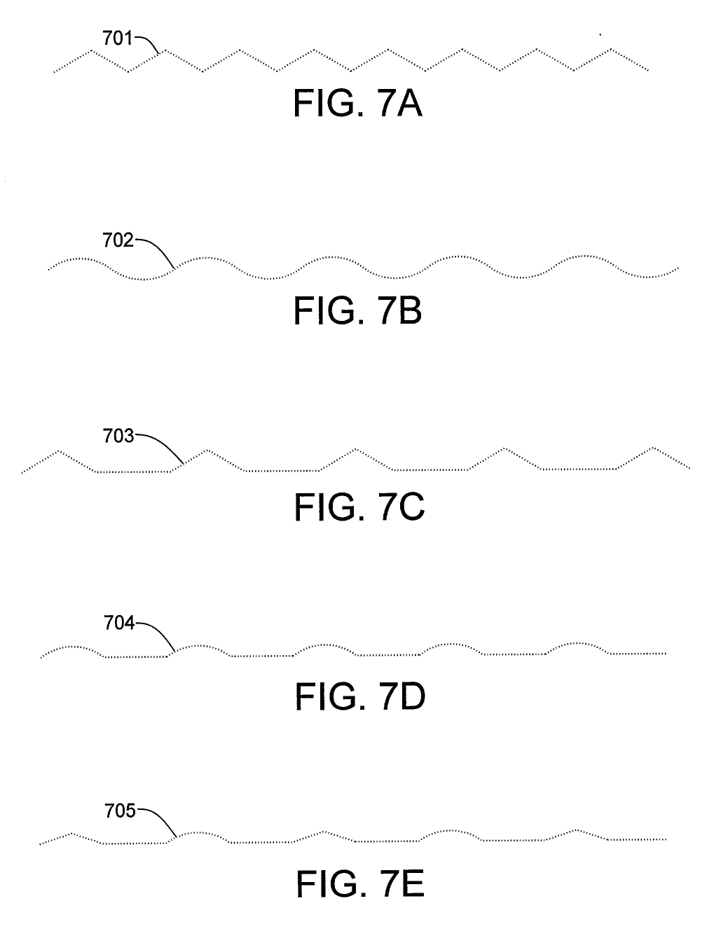

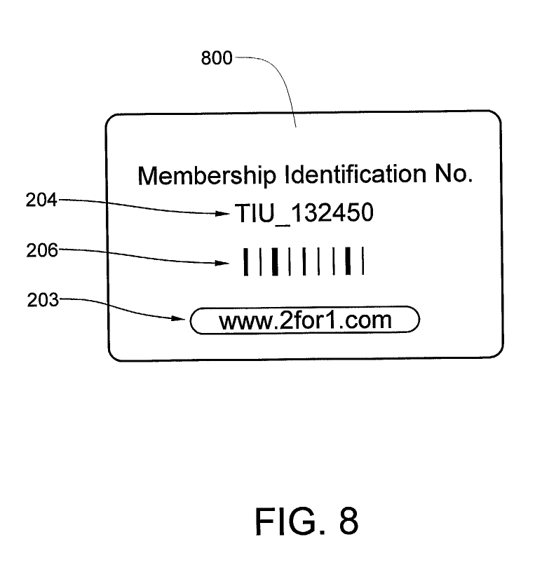

Still referring to FIG. 2, each of the coupon shells is surrounded by tear perforations 202 along its outer perimeter. Not only do the perforations facilitate singulation of multiple coupons contained on a single sheet, the perforations may be designed to enhance security. For example, laser-cut perforations, using a special pattern that is recognizable to the naked eye, yet not easily duplicatable, may be used. Five of many possible tear patterns, which may be used for this application, are shown in FIGS. 7A through 7E. In response to a registered consumer's indicated interest in a particular offer, that consumer may download certain data associated with that offer from the server system and, using his local printer, print the data within a preprinted coupon shell 201A, 201B, 201C, or 201D. Completion of a coupon shell by printing downloaded discount offer data therein results in a negotiable discount coupon. The number of discount coupons which may be printed by a single consumer for each authorized discount offer is limited in accordance with the restrictions imposed by the contracting merchant, retailer, or manufacturer.

Referring now to the singulated coupon shell of FIG. 2A, it will be noted that this coupon shell, as did each of the four shells 201A-201D, bears the Uniform Resource Locator (URL) 203 of the program manager (in this case, www.2for1.com) centered near the lower edge thereof, as well as a membership identification number 204 in the lower left-hand corner, which identifies the subscribing consumer to whom the security paper was sent, and an alphabetic prefix which identifies his location (e.g., state and county of residence). The membership identification number is also displayed as an encoded number 205, minus the alphabetic character prefix, in the lower right-hand corner of the coupon shell. In this case the number is encoded by expressing it as a base 8 number. The membership identification number is also displayed as a first scanable bar code 206. In order to enhance security, a membership card may be provided to each registered subscribing consumer by the program manager. The membership card has printed thereon at least the individual's membership identification number and optionally the name of the consumer. In order to redeem a discount coupon, the member may be required to show his membership card at the time of redemption. On the reverse side of each coupon shell 201A-201D are printed rules for coupon negotiability. The reverse side of each coupon shell currently provided to subscribing consumers have the following rules printed thereon:

“This Coupon is not valid with any other offer, promotion, or discount. Coupon is void if purchased, sold, or bartered for cash. Any alternation of this coupon is considered fraud and makes the coupon void. Coupons available only for the number of visits specified on the 2for1.com network. Any duplication or alternation of coupon serial numbers will result in termination of membership. One coupon per visit per customer. Valid for member only. Identification required.”

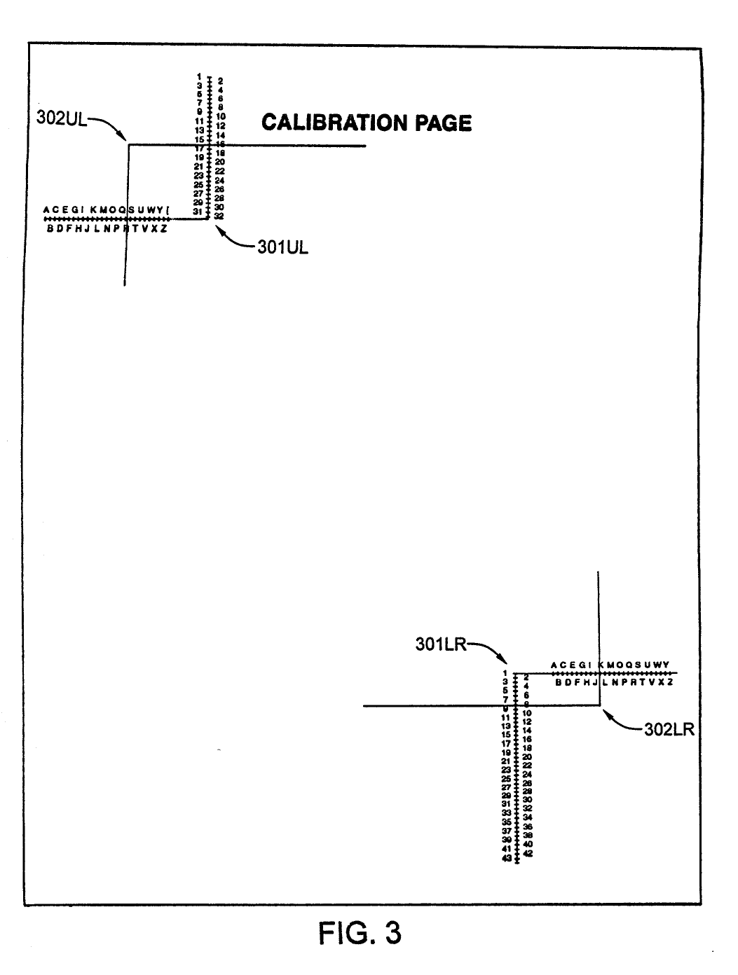

Referring now to the calibration page of FIG. 3, the subscribing consumer is asked to calibrate his printer so that the discount offer data downloaded from the server will be properly positioned within the coupon shells which are preprinted on the sheets of security paper (see FIG. 2). Preprinted calibration sheets are provided to the consumer, along with the sheets of pre-printed security paper. Each calibration sheet has a first grid 301UL, having x and y coordinates, preprinted in the upper left corner thereof, and a second grid 301LR, also having x and y coordinates, preprinted in the the lower right corner thereof. Calibration is accomplished by having the consumer print a test pattern on a calibration sheet provided by the program manager. The test pattern consists of two pairs of intersecting lines 302UL and 302LR, which respectively represent the upper left and lower right corner locations of a default-positioned-and-sized coupon printing field. Once the test pattern (302UL and 302LR) has been printed so that it is superimposed on the preprinted grid (301UL and 301LR), the consumer is asked to identify the two corners in terms of the alphanumeric x-y coordinates. For the case shown in FIG. 3, the upper left corner location corresponds most closely to the x-coordinate R and the y-coordinate 16. The lower left corner location, on the other hand, corresponds most closely to the x-coordinate K and the y-coordinate 8. Once this coordinate information has been made available to the server DPS, it can adjust the position and size of the coupon printing field. This may be accomplished by adding spaces before a line to be printed, changing the size of a particular type font so that a printed line fits within a horizontal space of a given size, varying the spacing between lines to provide better fit for a printed block of data, or some combination of the foregoing techniques. For a preferred embodiment of the invention, the calibration information is stored on the client system RC1, RC2, RC3, RC4, or RC5 and is uploaded to the server DPS for each printing operation.

Also for a presently preferred embodiment of the invention, a plug-in module provided by the program manager and downloadable from the server system, operates under the control of a network browser running on the client system. The plug-in module controls the printing of coupon data in coupon shells. The coupon data from the server system, which may include text data, graphics data and calibration data, is received by an Internet browser program running on the client system. The browser detects the incoming data from the server and sends it to the plug-in module. The browser may detect the receipt of such data through the use, for example, of file extensions unique to such data, or through the use of special control characters in the data stream, either of which the browser may be programmed to detect. Once detected, the browser routes the data to the plug-in module, which controls printing of the coupon data. The plug-in module parses the data and uses available calibration data—whether resident from the client system or received from the server system—to format the data for the local printer. Again, formatting may take the form of adding spaces before a line to be printed, changing the size of a particular type font so that a printed line fits within a horizontal space of a given size, varying the spacing between lines to provide better fit for a printed block of data, or any combination of the foregoing techniques. The plug-in module then sends the prepared information to the printer, where it may be printed within the blank coupon shells contained on a sheet of security paper. For a preferred embodiment of the invention, the calibration information is stored on the client system to avoid the necessity of repeatedly downloading information which remains constant for a particular printer. Also for a preferred embodiment of the invention, the plug-in module prevents downloaded coupon data from being electronically displayed, thereby increasing the difficulty required to manipulate, modify, and reprint the modified data. Also for a preferred embodiment of the invention, the data is encrypted by the server DPS and decrypted by the plug-in module.

For an alternative embodiment of the invention, printing is controlled by a print utility running on the server. Calibration information is uploaded to the server from the client system when each print operation is prepared, and the downloaded coupon data is downloaded to the client system and sent directly to the local printer.

There are several variables which may control the placement of print on a print medium by a printer that is receiving downloaded data: the type of printer; variability between different printers of the same type; the type of operating system being used for the download; and the type of network browser program being used for the download. If variability between different printers of the same type is negligible, then calibration may be performed for a particular type of printer for each possible combination of operating system and network browser by the printer manufacturer, the program manager, or some other third party. Calibration data for each printer/operating system/browser combination may be stored on a data storage medium, such as a CD-ROM, DVD-ROM or floppy disk, and provided to each subscribing consumer. In this manner, printer calibration tasks could be skipped by the individual subscribing consumer.

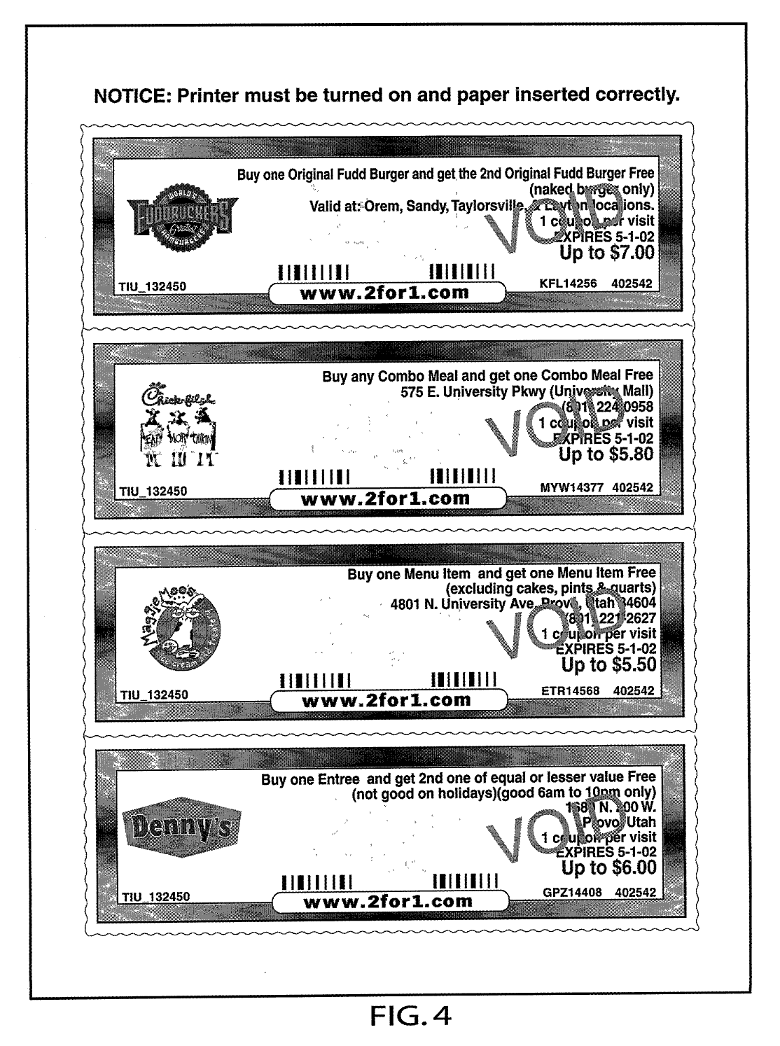

Referring now to FIG. 4, a subscribing consumer may choose to perform a trial printout of a set of coupons, in order to verify that proper calibration and formatting has taken place. The individual may indicate to the server that a printing operation will be performed as a test. Consequently, all of the discount coupons printed during the test will bear the label “VOID.” Multiple sheets of non-negotiable test print paper, having coupon shells preprinted thereon, may also be provided to the registered consumers by the program manager. These sheets of test print paper are printed just like the security paper sheets, but they have neither security features such as water marks or colored fibers, nor tear perforations.

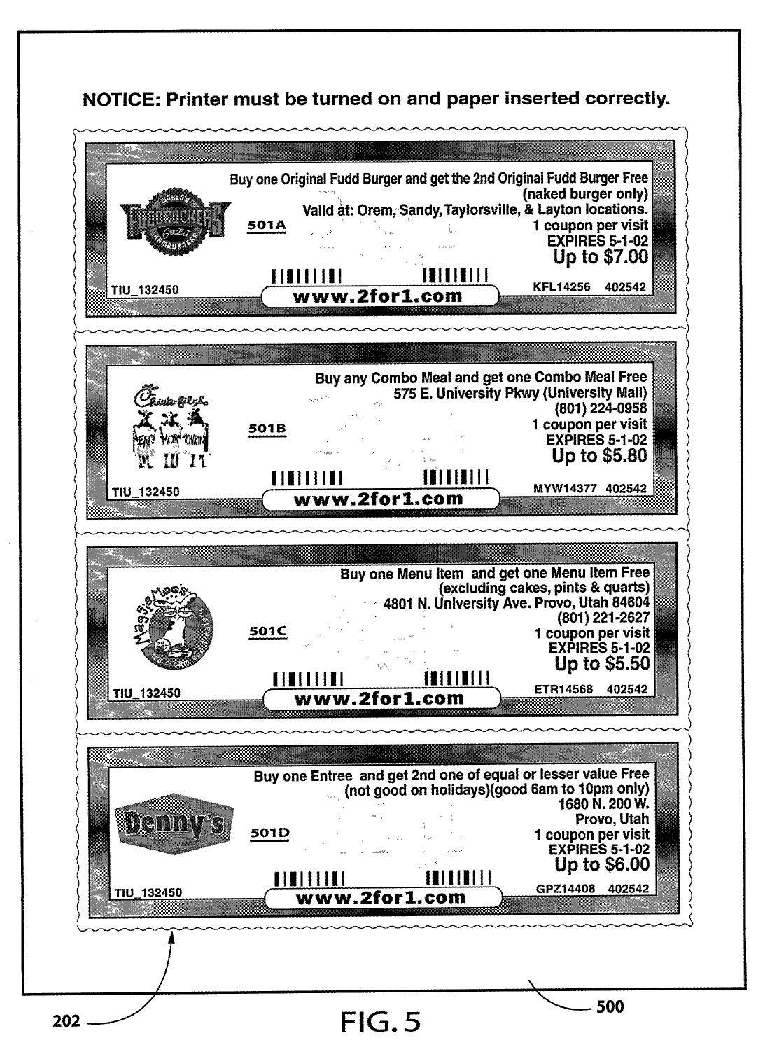

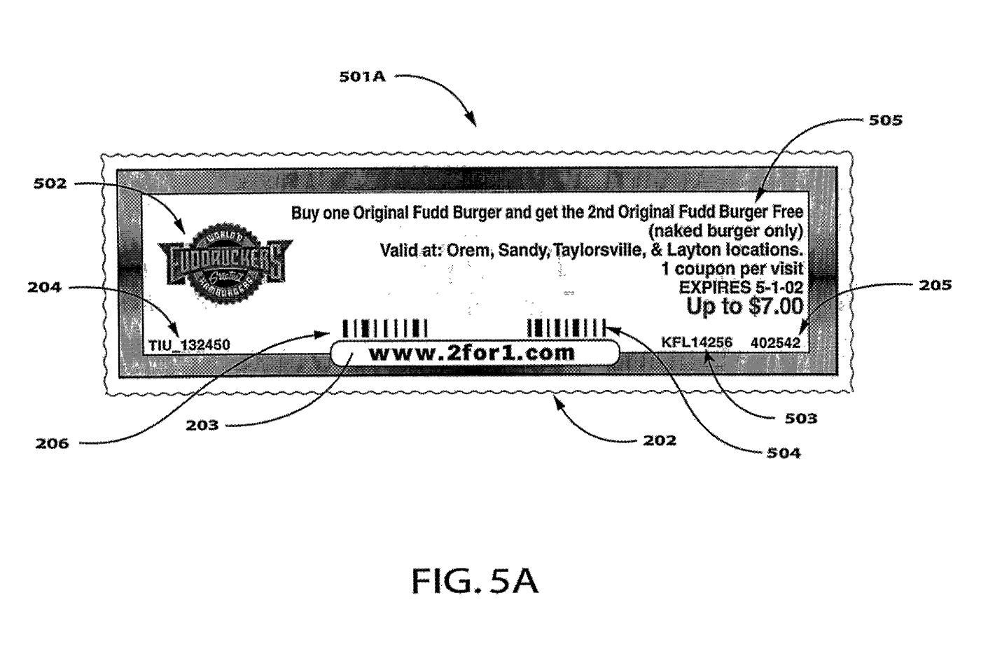

Referring now to FIG. 5, the coupon shells of FIG. 2 have been completed by printing discount offer data therein, resulting in a completed sheet of security paper 500 comprising four negotiable discount coupons. Referring to the singulated coupon of FIG. 5A, it will be noted that, in addition to the program manager's URL 203, the membership identification number 204, the encoded membership identification number 205, and the bar-coded membership identification number 206, each coupon also bears the name and/or logo 501 of the business (i.e., merchant, retailer or manufacturer) offering the discount in the extreme left portion of the coupon, a coupon serial number 502 (which identifies not only the offer, but the individual who completed the coupon and the date the coupon was completed, thereby uniquely identifying the negotiable coupon completed by the printing of the downloaded data), and a second scanable bar code 503, which corresponds to the coupon serial number. Also printed within the coupon shell are additional data lines which set forth the terms of the offer, the limitations of the offer, the address of the offeror, and other limitations, such as a limitation on the number of coupons which may be redeemed per visit, the expiration data and the maximum discount available.

Thus, for a preferred embodiment of a home-printed discount coupon, the coupon will have at least a membership identification number that was preprinted on the security paper and which identifies the subscribing consumer, as well as the unique coupon serial number that is assigned when the discount offer data from the discount offer database is printed within a coupon shell to create a negotiable discount coupon by the registered consumer. Both numbers may be in numerical format, scanable bar code format, or both. To complicate the task of forging membership identification numbers and coupon serial numbers, either one or both numbers may be printed as both a base-10 number and as a corresponding number in a base other than 10, or as a Roman numeral. As base-2 (binary) numbers and base-16 (hexadecimal) numbers are easily identifiable and translatable, a number in a base other than 2 or 16 is considered preferable.

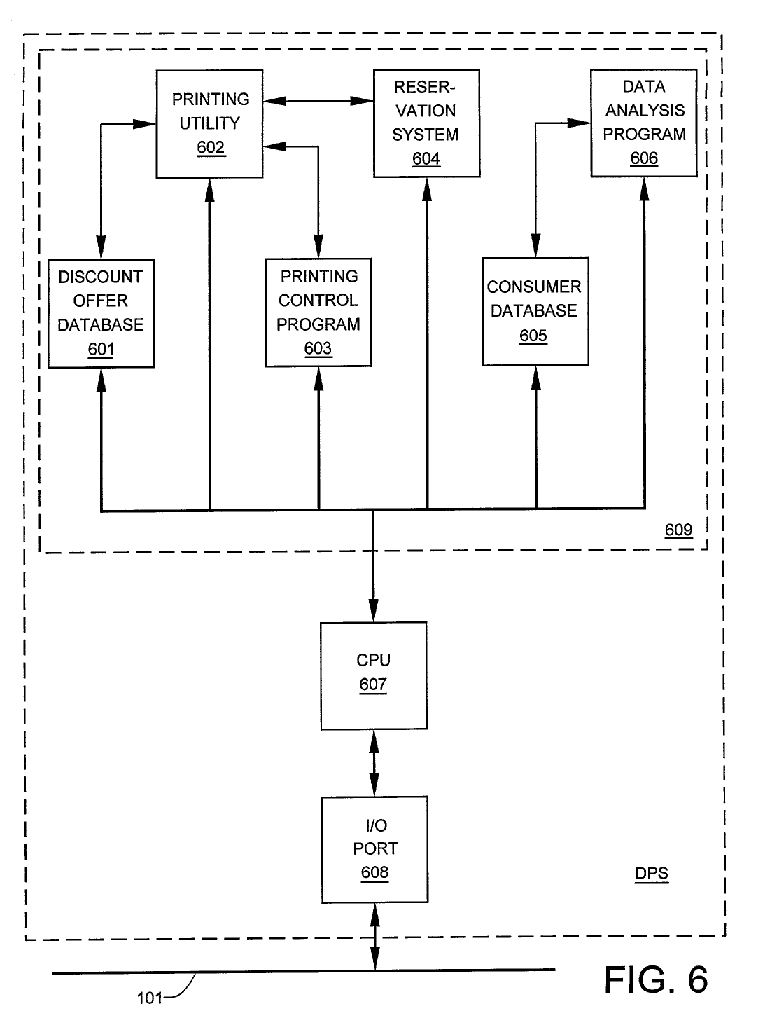

Referring now to FIG. 6, a description of the programs running on the discount program server (DPS) will now be undertaken. As heretofore stated, the DPS includes an available discount offer database 601, at least some of which are subject to restrictions imposed by the authorizing merchant, retailer, or manufacturer with regard to the number of times a single consumer may take advantage of a particular discount offer. The DPS also includes a print utility 602, which enables registered consumers to download and print discount offer data on the supplied security paper 200 using printers P1-P5 coupled to client systems RC1-RC5. A function of the print utility 602 is to send only the discount offer data to the client systems RC1-RC5 that will be sent to the printers P1-P5 for printing in the coupon shells 301A-301D.

Still referring to FIG. 6, the method for allocating the distribution of negotiable discount coupons to individual consumers utilizing a distributed processing network may be enhanced by providing a printing control program 603, which allows business establishments, such as restaurants, to access the server system DPS and provide inputs to the printing control program 603 which control the number of coupons that may be completed immediately prior to or during peak business periods (e.g., Friday or Saturday evenings), so as to limit the number of coupon-bearing customers during those peak periods. Coupled with the printing control program 603 is a reservation system 604, which allows registered consumers, who are denied printing of a coupon for immediate use at a particular business, to book a reservation at that business for a weekday or for a subsequent peak period for which the maximum number of discount coupons has not yet been printed.

The invention also provides a method for tracking the use of the coupons with an on-line database 605 and consumer data analysis program 606, accessible and updatable by the merchants, retailers and manufacturers, so that the validity of the coupons may be verified, and the buying habits of the consumers may be ascertained. Each coupon is printed with at least a unique identification number which identifies the subscribing consumer, and optionally with the subscribing consumer's name so that it may be identified with that subscribing consumer on the database.

Still referring to FIG. 6, it should be understood that this drawing figure is a simplified block diagram of server DPS, and that for the currently-preferred embodiment of the method of allocating the distribution of negotiable discount coupons, the available discount offer database 601, the printing utility 602, the printing control program 603, the reservation system 604, the consumer database, and the data analysis program 606 are all resident on a hard disk drive accessible by the server central processing unit 607. The input/output port 608, of course, couples the server DPS to the distributed processing network 101. The block diagram of FIG. 6 is shown primarily as a hierarchy of software modules, with the discount offer database 601 interacting bidirectionally with the printing utility 602, the printing utility 602 interacting bidirectionally with both the reservation system 604 and the printing control program 603, and the consumer database 605 interacting bidirectionally with the data analysis program 606. From a hardware perspective, the central processing unit 607 orchestrates all interactions, comparisons and any updates to a particular module.

Referring now to FIGS. 7A through 7E, five suggested patterns are shown which may be used for tear perforations around the perimeters of coupon shells. Pattern 701 is shaped like a saw-toothed waveform; pattern 702 is shaped like a sinusoidal waveform; pattern 703 is shaped like a half-wave rectified saw-tooth waveform; pattern 704 is shaped like a half-wave rectified sinusoidal waveform; and pattern 705 is shaped like a concatenation of half-wave rectified forms of saw-tooth and sinusoidal waveforms.

The coupon allocation system disclosed herein provides two levels of coupon tracking: the membership identification number 202, and the coupon serial number 501. Both sets of numbers are provided to a seller-accessible database for both coupon tracking and customer statistical analysis. Both the serial and the identification numbers of any tendered discount coupon may be entered in the on-line seller database and the validity of the coupons thereby verified. By accessing the seller database, the provider of goods or services will be able to verify that the a tendered negotiable discount coupon has been printed on the security paper assigned to the registered consumer, that the membership identification number 202 on the coupon corresponds to the membership identification number on consumer's membership card, and that the coupon's use is authorized under the terms of its discount program. The providers of the goods and services who access to the database are also able to enter data related to the use of tendered coupons and view accumulated data and statistical analyses of that data. The statistical analyses afford merchants and manufacturers an opportunity to better tailor their products, services, and advertising to customer behavior. For additional security, each subscribing consumer will be issued a discount program membership card having printed thereon at least a membership identification number which matches or correlates with the number pre-printed on coupon shells delivered to that subscribing consumer. When coupons are presented for redemption, the subscribing consumer may be asked to present his membership card for identification and verification. The membership card 800 of FIG. 8 includes the URL of the program manager 203 (in this case, www.2for1.com), a membership identification number represented both alphanumerically 204, and as a bar code 206. The bar code 206 permits the number to be recorded using a bar code scanner.

A subscribing consumer's preferences as to the types of goods or services in which he may have an interest may be determined using either a survey completed by the subscribing consumer at the time of his subscription, by surveys completed by him periodically during the term of his membership, or by automatically tracking his coupon data downloads and discerning his preferences. Each subscribing consumer has a personal account on the server system which he/she can access. Each account has a preferences section in which links to offers, corresponding to the preferences of the subscribing consumer, are placed. The presence of links to new offers in the preferences section of a subscribing consumer's account may be communicated to the subscribing consumer automatically via e-mail.

Although only several embodiments of the method of distributing negotiable discount coupons to individual consumers via a distributed processing network has been disclosed herein, it will be obvious to those having ordinary skill in the art that changes and modifications may be made thereto without departing from the scope and the spirit of the invention as hereinafter claimed.

What is claimed is:

1. A method for providing discount coupons to consumers, said method comprising the steps of:
gathering discount offers from participating business entities selected from the group consisting of manufacturers, retailers and merchants, for the sale of goods or services to members of a group of subscribing consumers, at least some of the discount offers being subject to restrictions imposed by a participating business entity;
forming a group of individually identifiable subscribing consumers;
providing a searchable database of gathered discount offers accessible via a distributed processing network;
providing sheets of security paper to each of the subscribing consumers, each sheet having at least one coupon shell preprinted thereon;
providing for the downloading of data corresponding to a selected discount offer, from the searchable database, via the network; and
providing for the printing, within a coupon shell, of the data downloaded from the database to create a negotiable discount coupon.

2. The method of claim 1, wherein said searchable database is loaded on at least one server computer system, and wherein a plug-in module is provided to each subscribing consumer for loading on a client computer system, said plug-in module controlling the printing of coupon information in coupon shells, in response to data, received by the plug-in module from said at least one server computer system.

3. The method of claim 2, wherein the data, which may include text data, graphics data and calibration data, is received by a network browser program running on the client system, said network browser detecting incoming coupon data from the server and routing it to the plug-in module.

4. The method of claim 3, wherein the plug-in module includes a routine that parses the data routed from the browser and transmits coupon data to the printer for printing on a sheet of security paper, thereby transforming at least one coupon shell into a negotiable coupon.

5. The method of claim 4, wherein the plug-in module includes a printer calibration and formatting program for formatting coupon data downloaded from the server system, as a function of calibration data generated in response to calibration inputs made by the subscribing consumer for a particular printer, so that the coupon can be accurately printed within said at least one coupon shell.

6. The method of claim 5, wherein the calibration data is stored on the client system.

7. The method of claim 5, wherein a coupon data formatting program is resident on the server system, said formatting program acting to format coupon data sent to the client system as a function of calibration data stored on the client system that was generated in response to calibration inputs made by the subscribing consumer for a particular printer, so that the coupon data can be accurately printed within said at least one coupon shell.

8. The method of claim 1, wherein the number of coupons which may be printed for each discount offer by an individual subscribing consumer is limited in accordance with any imposed restrictions associated with that offer.

9. The method of claim 1, wherein said distributed processing network is the Internet.

10. The method of claim 1, wherein each coupon shell includes at least one of the following features:
a water mark;
colored fibers;
a pre-printed membership identification number;
a pre-printed bar code;
a holographic stamp;
a two-dimensional code;
printing with concentric fine lines;
microprinting;
color-shifting ink.

11. The method of claim 1, wherein each sheet of security paper further includes perforated tear lines around the perimeter of each coupon shell, said tear lines facilitating the singulation of fully-printed individual coupons.

12. The method of claim 11, wherein each perforated tear line is laser formed.

13. The method of claim 12, wherein the tear lines incorporate a pattern recognizable to the naked eye that is not easily duplicated.

14. The method of claim 1, wherein each printed negotiable discount coupon includes a membership identification number, which identifies the subscribing consumer to whom the security paper, which the coupon incorporates, was sent, as well as a unique coupon serial number, which allows each coupon to be tracked and its authorized use verified.

15. The method of claim 1, wherein said consumer database contains multiple discount offers for the same good or service, said multiple offers featuring different discount levels, the offer or offers which feature lesser discount levels also imposing fewer redemption restrictions thereon.

16. The method of claim 14, wherein the coupon serial number identifies the offer, the subscribing consumer who completed the coupon, and the date the coupon was completed.

17. The method of claim 1, which further comprises the step of providing a business database, which participating businesses can access and input information from redeemed discount coupons, said database providing verification that any tendered coupon has been used in compliance with the imposed restrictions, and further providing a statistical analysis of the purchasing habits of the subscribing consumers who have tendered those discount coupons.

18. The method of claim 1, which further comprises the steps of:
providing a membership card to each subscribing consumer, said membership card having printed thereon a membership identification number that uniquely identifies each subscribing consumer;
including in each pre-printed coupon shell on the security paper, a number which matches the membership number of the subscribing consumer to whom the sheets of security paper are sent, so that merchants can verify that any coupons negotiated by a subscribing consumer have printed thereon a number which matches the membership number printed on the card of that subscribing consumer.

19. The method of claim 1, which further comprises the steps of:
classifying the discount offers received from manufacturers, retailers and merchants into various classes with regard to the types of goods or services to which those offers apply and automatically sending an e-mail message to a subscribing consumer when the class of a newly available offer coincides with at least one preference established by the subscribing consumer as to the types of goods or services in which he has an interest, the e-mail message alerting the subscribing consumer that the coinciding offers have been placed in a preference section of a personal account assigned to that subscribing consumer.

20. The method of claim 19, wherein preferences are established by the subscribing consumer by completing a survey provided by the program provider.

21. The method of claim 20, wherein preferences are established by automatically tracking coupon data downloads of the subscribing consumer, and discerning his preferences from those downloads.

22. A coupon distribution system comprising:
a host computer system coupled to a data communications network, said host computer system having a memory, in which is stored discount offer data provided by at least one manufacturer, retailer or merchant, and registered user identification data;
a plurality of client computer systems at remote locations, each client computer system accessible by a registered user; each client computer system having a printer coupled thereto, and each client computer system capable of establishing electrical communication with the host computer system over the data communications network so that a registered user can view the discount offer data stored within the host computer system memory;
security paper provided to only registered users, each sheet thereof having at least one coupon shell preprinted thereon;
a printer calibration and formatting program for formatting downloads of discount offer data stored in the host computer system memory, in response to calibration inputs made by a registered user for a particular printer, so that discount offer data selected by a registered user can be accurately printed within a coupon shell of a sheet of the security paper.

23. The coupon distribution system of claim 22, wherein multiple coupon shells are preprinted on a single sheet of security paper.

24. The coupon distribution system of claim 23, wherein each sheet of security paper further includes perforated tear lines around the perimeter of each coupon shell, said tear lines facilitating the singulation of fully-printed individual coupons.

25. The coupon distribution system of claim 26, wherein each perforated tear line is formed by a laser.

26. The method of claim 25, wherein the tear lines incorporate a pattern recognizable to the naked eye that is not easily duplicated.

27. A method for allocating discount coupons to consumers, comprising the steps of:
enlisting at least one business entity selected from the group consisting of manufacturers, retailers and merchants, who is willing to offer a discount on the sale of goods or services to a group of identifiable consumers;
registering a group of identifiable consumers;
providing a discount offer look-up and coupon printing service accessible via a distributed processing network;
providing sheets of security paper to each of the registered consumers, each sheet having at least one coupon shell preprinted thereon, each shell containing a preprinted indicia traceable to the registered consumer who received the sheet of security paper on which that coupon shell was printed; and
allowing each of the registered consumers to access the offer look-up and printing service over the network, and to print selected discount offer data from the service in the coupon shells, thereby creating a negotiable discount coupon for each shell so printed, the coupon quantity printable by each registered consumer for each discount offer corresponding to that authorized by the respective business entity.

28. The coupon distribution system of claim 27, wherein each sheet of security paper contains multiple coupon shells preprinted thereon.

29. The coupon distribution system of claim 28, wherein each sheet of security paper further includes perforated tear lines around the perimeter of each coupon shell, said tear lines facilitating the singulation of fully-printed individual coupons.

30. The coupon distribution system of claim 31 wherein each perforated tear line is formed by a laser.

31. The method of claim 30, wherein the tear lines incorporate a pattern recognizable to the naked eye that is not easily duplicated.

32. In a distributed processing network comprising at least one server computer system and multiple client computer systems by means of which data can be downloaded from and uploaded to said at least one server system, a plug-in module for a network browser program running on a client computer system, said module comprising:
a calibration routine, which stores coordinate values identified by an operator on a calibration sheet, which correspond to position limits of a block of unadjusted downloaded test data actually printed, without format adjustments, on the calibration sheet by a particular printer or particular type of printer;
a formatting routine, which formats downloaded non-test data, as a function of the identified coordinates, so that it will be accurately positioned by the particular printer or the particular type of printer in desired locations on the print medium.
printing routine, which directs downloaded data to the particular printer or the particular type of printer.

33. The module of claim 32, wherein the printing routine prevents certain downloaded data from being electronically displayed to a user.

34. The method of claim 33, wherein the standard size print medium is a sheet of security paper having coupon shells pre-printed thereon.

35. The method of claim 34, wherein the identified coordinates are stored on the client system to avoid the necessity of repeatedly downloading from the server, information which remains constant for the particular printer or the particular type of printer.

36. In a distributed processing network comprising at least one server computer system and multiple client computer systems, a method of calibrating a particular printer coupled to a client system, so that said printer can accurately position data downloaded from the server system to the client system on a print medium of known dimensions, said method comprising the steps of:
identifying coordinates on a calibration sheet, which correspond to position limits of a block of unadjusted downloaded test data actually printed on the calibration sheet by said printer; and
formatting downloaded non-test data, as a function of the identified coordinates, so that it is accurately positioned by the printer in desired locations on the print medium.

37. The method of claim 36, wherein position limit coordinates for a particular printer are stored by the server computer system, and the server computer system formats any non-test data downloaded to the client computer system.

38. The method of claim 36, wherein position limit coordinates for a particular printer are stored by the client computer system, and the client computer system formats any non-test data downloaded to the client computer system, under the control of a plug-in module which operates in conjunction with a network browser program.

39. The method of claim 36, which further comprises the steps of:
providing a print medium having perforated tear lines which facilitate the singulation of the print medium into smaller parts, and on which data downloaded from said at least one server computer system can be printed within at least one of the smaller parts.

40. The method of claim 39, wherein each perforated tear line is laser formed.

41. The method of claim 40, wherein the tear lines incorporate a pattern recognizable to the naked eye that is not easily duplicated.

42. A method for calibrating a particular printer or type of printer for the printing of data downloaded over a distributed processing network so that data can be precisely positioned on a print medium of a size acceptable to that particular type of printer, said method comprising the steps of:
identifying coordinate values on a calibration sheet, which correspond to position limits of a block of unadjusted test data actually printed by the particular printer or type of printer thereon, in conjunction with a particular operating system and a particular network browser; and
providing a program for formatting non-test data downloaded over the network, as a function of the identified coordinate values obtained for that particular printer or type of printer, that particular operating system and that particular network browser.

43. The method of claim 42, wherein the steps are performed by a user of a remote client system coupled to the network.

44. The method of claim 42, wherein the steps are performed by the provider of the calibration method.

45. The method of claim 42, which is implemented as a plug-in module which operates with the network browser.
